(19) United States
(12) Patent Application Publication
(10) Pub. No.: US 2026/0117813 A1
(43) Pub. Date: Apr. 30, 2026

(54) SECURING THIN MATERIALS WITH QUICK FASTENING ASSEMBLIES

(71) Applicant: ZEPHER FLIGHT LABS, Bingen, WA (US)

(72) Inventors: Jacob S. Allen, Hood River, OR (US); Robert D. Andrews, White Salmon, WA (US)

(21) Appl. No.: 18/932,759

(22) Filed: Oct. 31, 2024

(51) Int. Cl. F16B 37/04; C09J 5/00; C09J 7/38; F16B 37/00

(52) U.S. Cl. CPC F16B 37/048; C09J 5/00; C09J 7/38; F16B 37/005; C09J 2301/302

(57) ABSTRACT

A fastening assembly includes a nut and a pressure adhesive material. The nut defines a channel and has an upper end portion and a lower end portion. The pressure adhesive material has a lower surface and an upper surface configured to secure to the lower end portion of the nut. The lower surface of the pressure adhesive material is configured to adhere to a first substrate for securing the nut to the first substrate to prevent the nut from separating from the first substrate and to prevent the nut from rotating relative to the first substrate when the fastener is threaded into the nut for securing the first substrate to a second substrate.

### TECHNICAL FIELD

This disclosure relates to fastening assemblies for thin materials such as thin metals or thin composites which have a small thickness relative to their other dimensions (length and width) and/or in comparison to conventional thicknesses in their respective categories.

### BACKGROUND

A few industries like small, unmanned systems have a number of small components and/or areas that are difficult to access. Some of these components include thin materials, such as thin metals or thin composites, which are fastened to one or more substrates that can include other materials, components, or surfaces, and which may also include thin materials. To effectuate such fastening, lightweight fasteners are required; however, attaching a nut (e.g., to a fastener) within these difficult areas to access, like an interior of a small assembly such as an unmanned aerial vehicle, can be challenging, particularly when these materials, components, or surfaces are thin.

Thin materials are those with minimal thickness relative to their other dimensions, leading to specific characteristics like flexibility, lightweight, and high surface area to volume ratio, which are leveraged in various industrial applications.
Thickness: Thin materials have a reduced thickness, often measured in millimeters or micrometers. For metals, thin materials may range from less than a millimeter to a few millimeters thick (e.g., five millimeters or less), while for composites, the thickness can be similarly small, depending on the application.
Flexibility: Due to their reduced thickness, these thin materials often exhibit increased flexibility or pliability compared to their thicker counterparts. This characteristic is particularly important in applications requiring lightweight or easily formable materials.
Weight: Thin materials are generally lightweight, making them suitable for applications where reducing mass is critical, such as in aerospace, automotive, and electronics industries.
Surface Area to Volume Ratio: Thin materials have a high surface area relative to their volume, which can impact properties like heat transfer, electrical conductivity, and structural strength.
Application-Specific Requirements: The definition of “thin” can vary based on the specific application or industry standards. For instance, in electronics, thin metal films might be on the order of micrometers, whereas in construction, thin metal sheets might be a few millimeters thick.

In many cases, the use of a free hex-style nut for fastening is unacceptable in industries like the small, unmanned systems since the interior of assemblies of these systems will not be accessible after manufacture or will present an elevated risk of part loss or damage to the operational system.

Solutions currently available are special steel “nut plates” that are attached by bonding or riveting. Riveting a nut plate to a substrate is difficult, requires additional edge spacing, specialty tools, and a material thickness adequate to avoid broad damage and deformation to the substrate. Bond-on nut plates often require skill and many manufacturing steps to prepare the substrate, mix the adhesive, perform the installation, and allow sufficient time to cure, clean up and check out. In many cases, these tasks are arduous, susceptible to mistakes, and require skills and assembly tooling which are uncommon. These nut plates add unnecessary weight due to the use of glue that squeezes out around the bonding edge but does not provide any additional strength. Also, the proper application of these nut plates can only be performed on substrates which are readily bondable by adhesives that harden like epoxy and urethane. These adhesives are not useful to use on unsanded surfaces or many of the broad family of common materials like polyethylene, Polypropylene, Vinyl, and other thermoplastics. Additionally, many thermoset matrix materials can be difficult to bond to during the post-cure, off-gassing phase which can cause significant delays in manufacturing. These challenges mean that the bond-on nut plates can only provide solutions for some materials. Accordingly, a solution does not exist for quickly fastening thin composite or plastic parts in a very lightweight, easy, and low cost way.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying figures of which:

FIG. 1 is a top, perspective view, with parts separated, of fastening assemblies being secured to a pair of substrates in accordance with the principles of this disclosure;

FIG. 2 is a bottom, perspective view, with parts separated, illustrating the fastening assemblies of FIG. 1 being secured to the pair of substrates after pressure adhesive films of the fastening assemblies are secured to nuts of the fastening assemblies;

FIG. 3 is a top, perspective view, illustrating the fastening assemblies of FIGS. 1 and 2 coupling the pair of substrates together; and

FIG. 4 is a side, cross-sectional view, illustrating an insert disposed within a nut of a fastening assembly; and

FIG. 5 is a side, cross-sectional view of a pressure adhesive assembly including a pressure adhesive film with upper and lower protective films shown partially peeled away from respective top and bottom adhesive surfaces of the pressure adhesive film.

Further details and aspects of exemplary aspects of the disclosure are described in more detail below with reference to the appended figures. Any of the above aspects and aspects of the disclosure may be combined without departing from the scope of the disclosure.

### DETAILED DESCRIPTION

Although illustrative systems of this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the figures, and specific language will be used to describe the same. It will nevertheless be understood that no limitation of the scope of this disclosure is thereby intended. Any alterations and further modifications of this disclosure features illustrated herein, and any additional applications of the principles of this disclosure as illustrated herein, which would occur to one skilled in the relevant art and having possession of this disclosure, are to be considered within the scope of this disclosure.

All directional references (e.g., upper, lower, etc.) are only used for identification purposes to aid the reader's understanding of the present disclosure, and do not create limitations, particularly as to the position, orientation, or use of aspects of the disclosure described herein. Connection references (e.g., attached, coupled, connected, joined, etc.) are to be construed broadly and can include intermediate structural elements between a collection of elements and relative movement between elements unless otherwise indicated. Accordingly, connection references do not necessarily infer that two elements are directly connected and in fixed relation to one another. The exemplary drawings are for purposes of illustration only and the dimensions, positions, order and relative sizes reflected in the drawings attached hereto can vary.

As used herein, the terms “first,” “second,” etc. may be used interchangeably to distinguish one component from another and are not intended to signify location or importance of the individual components. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third. ” In such instances, it should be understood that such descriptors are used merely for ease of referencing multiple elements or components.

The singular forms “a,” “an,” and “the” include plural references unless the context clearly dictates otherwise.

Although this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the drawings, and specific language will be used to describe the same. It will nevertheless be understood that no limitation of the scope of this disclosure is thereby intended. Any alterations and further modifications of the inventive features illustrated herein, and any additional applications of the principles of this disclosure, as illustrated herein, which would occur to one skilled in the relevant art and having possession of this disclosure, are to be considered within the scope of this disclosure.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ this disclosure in any appropriately detailed structure.

Approximating language, as used herein, is applied to modify any quantitative representation that could permissibly vary without resulting in a change in the basic function to which it is related. Accordingly, a value modified by a term or terms, such as “about,” “approximately,” “generally,” and “substantially” is not to be limited to the precise value specified. In at least some instances, the approximating language may correspond to the precision of an instrument for measuring the value, or the precision of the methods or the machines for constructing the components and/or the systems or manufacturing the components and/or the systems. For example, the approximating language may refer to being within a one, two, four, ten, fifteen, or twenty percent margin in either individual values, range(s) of values and/or endpoints defining range(s) of values.

In the following description, well-known functions or constructions are not described in detail to avoid obscuring the present disclosure in unnecessary detail.

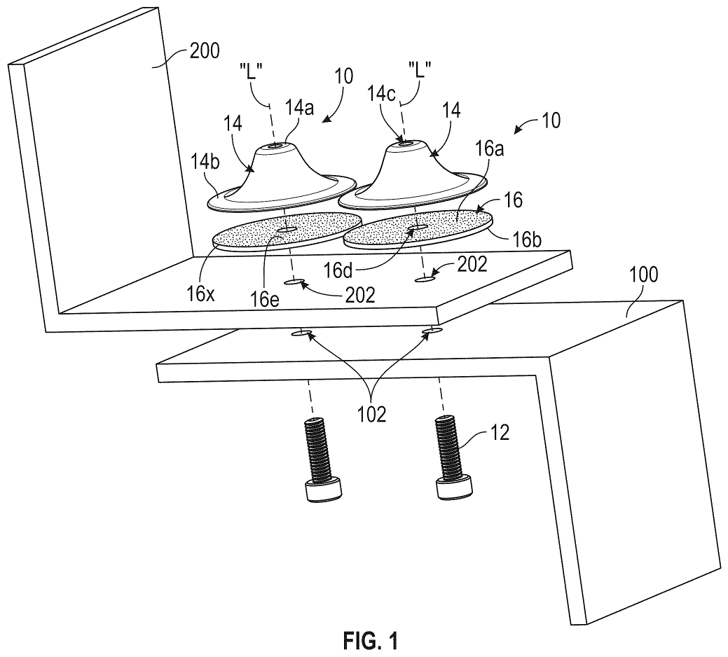

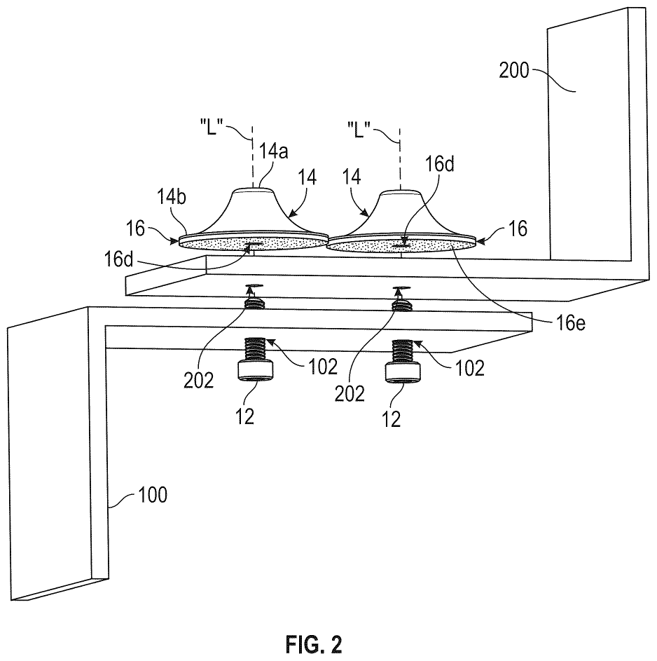

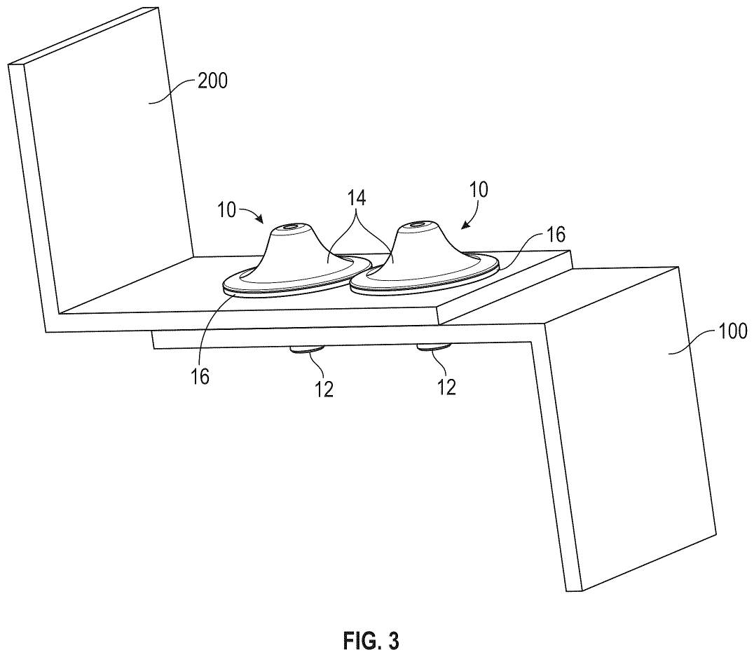

With reference to FIGS. 1-3, a fastening assembly 10 defines a central longitudinal axis “L” and generally includes a fastener 12, a nut 14, and a pressure adhesive material or film 16 that couple together to secure, for instance, a first substrate 100 to a second substrate 200. Each of the first and second substrates 100, 200 may define fastener openings 102, 202 therethrough for receiving the fastener 12 therethrough to enable the fastener 12 to threadedly couple to the nut 14 and to facilitate securement of the fastening assembly 10 to the first and/or second substrates 200. As can be appreciated, the fastener 12 can be any suitable fastener such as a threaded screw, which may include any suitable material such a metallic material. And any number or arrangement of fastening assemblies 10 (e.g., a fastening system) can be utilized to secure the first and second substrates 110, 200, or any number of substrates, together.

The nut 14 of the fastening assembly 10 has an upper end portion 14a, a lower end portion 14b that is wider than the upper end portion 14a and a channel 14c (e.g., a pilot hole) defined centrally through the nut 14 from the upper end portion 14a to the lower end portion 14b. The channel 14c, which may be threaded, is configured to threadedly receive the fastener 12 therein. The nut 14 may have a conical configuration (e.g., a volcano shape) such that lower end portion 14b tapers toward the upper end portion 14a. In some aspects, the nut 14 can have any suitable shape and/or configuration such as a cube. In aspects, the nut 14 is 3D printed and may include any suitable material such any suitable polymeric, metallic, ceramic, and/or any other suitable synthetic or natural material. In certain aspects, the nut 14 includes a plastic material that deforms when the fastener 12 is threaded into the channel 14c such that the fastener 12 cuts threads along the channel 14c as the fastener 12 is initially tightened into the channel 14c of the nut 14. In some aspects, the nut 14 is metallic and includes machined threads defined along the channel 14c for threadedly coupling to the fastener 12. In certain aspects, the nut 14 may be a hex nut or the like.

The pressure adhesive film 16 of the fastening assembly 10 can have any suitable configuration and includes a body 16x having an upper surface 16a and a lower surface 16b, one or both of which may include any suitable adhesive material 16e (e.g., single or double-sided adhesive). In aspects, the pressure adhesive film 16 has a disc shape. The upper surface 16a of the pressure adhesive film 16 is configured to be secured (e.g., adhered) to the lower end portion 14b of the nut 14 and the lower surface 16b of the pressure adhesive film 16 is configured to be secured (e.g., adhered) to a surface of one of the first or second substrates 100, 200. The pressure adhesive film 16 is configured to hold the nut 14 on one of the first and/or second substrates 100, 200 (e.g., before tightening the fastener 12) so that the nut 14 does not need to be separately held in place, such as with a separate tool like a wrench, while engaging (and tightening) the fastener 12 to the nut 14. Indeed, the pressure adhesive film 16 is configured to prevent the nut 14 from rotating relative to the first and/or second substrates 100, 200 when the pressure adhesive film 16 to secured to the nut 14 on one side of the pressure adhesive film 16 and a surface of one of the first or second substrates 100, 200 on another side of the pressure adhesive film 16.

Advantageously, since the pressure adhesive film 16 of the fastening assembly 10 only needs to provide some torque resistance as the fastener 12 is started and then less torque resistance when the parts all come together and the fastener 12 is tightened, a “better”, “permanent” bond does not need to be made. The pressure adhesive film 16 holds the nut 14 in place until the parts are assembled with the fastener 12 and then crush friction is present at an interface of the pressure adhesive film 16 and the first and/or second substrate 100, 200 further limiting an amount of torque required for holding the nut 14 in place.

The pressure adhesive film 16 of the fastening assembly 10 further defines a fastener opening 16d through a center of the pressure adhesive film 16 for enabling the fastener 12 to be advanced through the pressure adhesive film 16 for threadedly coupling to the fastener 12 to the nut 14. The fastener opening 16d is configured to be coaxially aligned with the channel 14a of the nut 14 when the pressure adhesive film 16 is secured to a bottom surface of a lower end portion 14b of the nut 14.

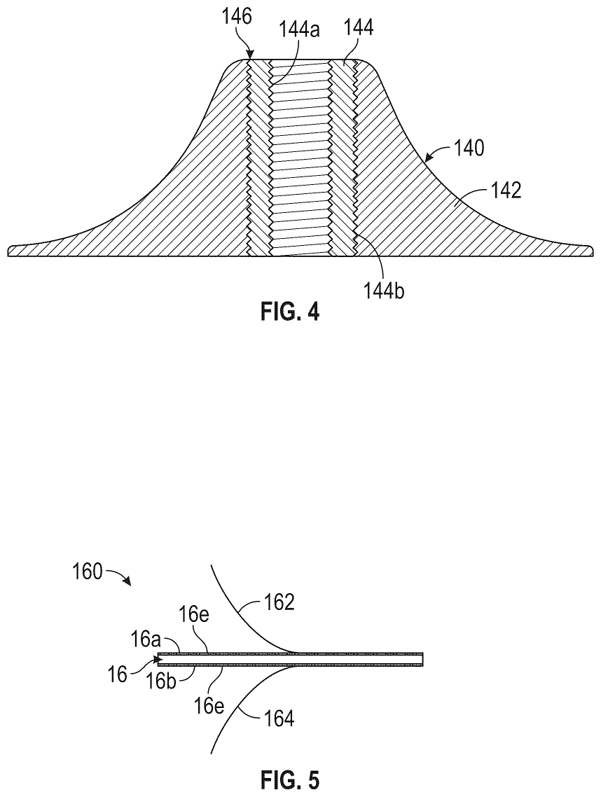

In some aspects, the nut 14 of the fastening assembly 10 is a composite material and/or includes two or more different materials. As seen in FIG. 4, for instance, a nut 140 may have a body 142 with polymeric material and includes a metallic insert 144 that couples to the nut 140. For example, the insert 144 may be a tubular insert having any suitable shape including a circular and/or non-circular cross section such as square, star, pentagon, hexagon, etc. For instance, the insert 144 may be secured in a channel 146 (or pilot hole) via any suitable securement technique such as snap-fit, friction-fit, adhesion, welding, crimping, fastening, threading or like. As can be appreciated, the channel 146 may or may not extend all the way through the nut 140. The insert 144 may define internal machine threads 144a for threadedly coupling to the fastener 12 and/or may include external machine threads 144b for threadedly coupling to the nut 140 (e.g., where channel 146 may be threaded or can be configured to be cut into to form threads along the channel 146 when the insert 144 is threaded into the channel 146). In some aspects, the insert 144 may be secured within the channel 146 utilizing any suitable securement technique such as press-fit, friction-fit, snap-fit, etc.

As seen in FIG. 5, in some aspects, a pressure adhesive assembly 160 may include one or more protective layers 162, 164, which may be protective films, for protecting an underlying pressure adhesive film 16. The protective layers 162, 164 are removably secured to the upper surface 16a and/or the lower surface 16b of the pressure adhesive film 16 and are configured to be can be removed (e.g. peeled off) to expose the adhesive material 16e on the respective upper and/or lower surface 16a, 16b for enabling the pressure adhesive film 16 to be secured (e.g. adhered) to the nut 14 (or nut 140) and/or the first and/or second substrates 100, 200.

In various aspects, one or more components of the fastening assemblies of this disclosure (e.g., the nut 14, the pressure adhesive material 16, etc.) can include one or more surface textures, coatings, and/or layers such as depressions, indicia, voids, protuberances, and/or the like, which may have any suitable configuration, pattern, and/or which may be disposed randomly. Indeed, one or more of these components can have any suitable geometrical configuration including any shape and/or arrangement of surfaces and/or edges (e.g., planar, curved, concave, convex, linear, chamfered, textured, marked, beveled, rounded, cornered, etc., or combinations thereof).

As can be appreciated, securement of any of the components of the disclosed systems can be effectuated using known securement techniques such welding, crimping, gluing, fastening, etc.

The phrases “in an aspect,” “in aspects,” “in various aspects,” “in some aspects,” or “in other aspects” may each refer to one or more of the same or different aspects in accordance with the present disclosure. Similarly, the phrases “in an aspect,” “in aspects,” “in various aspects,” “in some aspects,” or “in other aspects” may each refer to one or more of the same or different aspects in accordance with the present disclosure. A phrase in the form “A or B” means “(A), (B), or (A and B). ” A phrase in the form “at least one of A, B, or C” means “(A); (B); (C); (A and B); (A and C); (B and C); or (A, B, and C).”

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

Further aspects of the present disclosure are provided by the subject matter of the following clauses.
1. A fastening assembly, comprising:
   a nut defining a channel along a longitudinal axis of the nut, the nut having an upper end portion and a lower end portion; and
   a pressure adhesive film having a lower surface and an upper surface secured to the lower end portion of the nut, the pressure adhesive film defining a fastener opening that extends through the upper surface and the lower surface, the fastener opening coaxially aligned with the channel of the nut to enable the lower surface of the pressure adhesive film to surround a fastener opening of a first substrate for securing the pressure adhesive film and the nut to the first substrate to prevent the nut from separating from the first substrate and to prevent the nut from rotating relative to the first substrate when a fastener is threaded through the first substrate, the pressure adhesive film, and into the nut for securing the first substrate to a second substrate.
2. The fastening assembly of clause 1, wherein the upper surface and the lower surface of the pressure adhesive film include adhesive material.
3. The fastening assembly of any of the preceding clauses, wherein the channel of the nut is threaded.
4. The fastening assembly of any of the preceding clauses, wherein the lower end portion of the nut is wider than the upper end portion of the nut.
5. The fastening assembly of any of the preceding clauses, wherein the lower end portion of the nut tapers toward the upper end portion of the nut.
6. The fastening assembly of any of the preceding clauses, wherein the nut includes polymeric material.
7. The fastening assembly of any of the preceding clauses, wherein the polymeric material of the nut is configured to enable threaded rotation of the fastener along the channel of the nut to cut threads into the polymeric material of the nut to threadedly couple the nut to the fastener.
8. The fastening assembly of any of the preceding clauses, wherein the nut includes 3D printed material.
9. The fastening assembly of any of the preceding clauses, wherein the pressure adhesive film includes at least one protective layer removably attached to the lower surface of the pressure adhesive film.
10. The fastening assembly of any of the preceding clauses, wherein the nut includes an insert that is arranged along the longitudinal axis of the nut and is configured to threadedly couple to the fastener.
11. A method for securing substrates together with a fastening assembly, the method comprising:
   securing a nut to a first substrate having a thickness of five millimeters or less with a pressure adhesive film to hold the nut on the first substrate;
   threading a fastener through a second substrate, the first substrate, the pressure adhesive film, and into the nut; and
   with the pressure adhesive film, preventing the nut from rotating relative to the first substrate and the pressure adhesive film as the fastener is threaded into the nut.
12. The method of any of the preceding clauses, further comprising removing a layer from the pressure adhesive film to expose adhesive material of the pressure adhesive film for securing the pressure adhesive film to the first substrate.
13. The method of any of the preceding clauses, further comprising cutting threads into a channel of the nut as the fastener is threaded into the nut to threadedly couple the fastener to the nut.
14. The method of any of the preceding clauses, wherein preventing the nut from rotating relative to the first substrate and the pressure adhesive film when the fastener is threaded into the nut includes preventing the nut from rotating relative to the first substrate when threading the fastener to the nut after the nut is adhered to the first substrate with the pressure adhesive film.
15. The method of any of the preceding clauses, wherein the preventing of the nut from rotating relative to the first substrate with only the pressure adhesive film is continuous from a start of the threading of the fastener into the nut to an end of the threading of the fastener into the nut.
16. The method of any of the preceding clauses, wherein threading the fastener through the second substrate, the first substrate, the pressure adhesive film, and into the nut includes securing the first substrate to the second substrate.
17. The method of any of the preceding clauses, wherein threading the fastener through the nut includes threading the fastener through a channel defined through the nut.
18. The method of any of the preceding clauses, further comprising inserting an insert into the nut before threading the fastener into the nut, and wherein threading the fastener through the nut includes threading the fastener into the insert
19. The method of any of the preceding clauses, further comprising securing the pressure adhesive film to the nut before securing the nut to the first substrate.
20. A fastening assembly, comprising:
   a fastener;
   a nut defining a channel and having an upper end portion and a lower end portion; and
   a pressure adhesive material having a lower surface and an upper surface configured to secure to the lower end portion of the nut, the lower surface of the pressure adhesive material configured to adhere to a first substrate for securing the nut to the first substrate to prevent the nut from separating from the first substrate and to prevent the nut from rotating relative to the first substrate when the fastener is threaded into the nut for securing the first substrate to a second substrate.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A fastening assembly, comprising:
a nut defining a channel along a longitudinal axis of the nut, the nut having an upper end portion and a lower end portion; and
a pressure adhesive film having a lower surface and an upper surface secured to the lower end portion of the nut, the pressure adhesive film defining a fastener opening that extends through the upper surface and the lower surface, the fastener opening coaxially aligned with the channel of the nut to enable the lower surface of the pressure adhesive film to surround a fastener opening of a first substrate for securing the pressure adhesive film and the nut to the first substrate to prevent the nut from separating from the first substrate and to prevent the nut from rotating relative to the first substrate when a fastener is threaded through the first substrate, the pressure adhesive film, and into the nut for securing the first substrate to a second substrate.

2. The fastening assembly of claim 1, wherein the upper surface and the lower surface of the pressure adhesive film include adhesive material.

3. The fastening assembly of claim 2, wherein the channel of the nut is threaded.

4. The fastening assembly of claim 3, wherein the lower end portion of the nut is wider than the upper end portion of the nut.

5. The fastening assembly of claim 4, wherein the lower end portion of the nut tapers toward the upper end portion of the nut.

6. The fastening assembly of claim 5, wherein the nut includes polymeric material.

7. The fastening assembly of claim 6, wherein the polymeric material of the nut is configured to enable threaded rotation of the fastener along the channel of the nut to cut threads into the polymeric material of the nut to threadedly couple the nut to the fastener.

8. The fastening assembly of claim 5, wherein the nut includes 3D printed material.

9. The fastening assembly of claim 1, wherein the pressure adhesive film includes at least one protective layer removably attached to the lower surface of the pressure adhesive film.

10. The fastening assembly of claim 1, wherein the nut includes an insert that is arranged along the longitudinal axis of the nut and is configured to threadedly couple to the fastener.

11. A method for securing substrates together with a fastening assembly, the method comprising:
securing a nut to a first substrate having a thickness of five millimeters or less with a pressure adhesive film to hold the nut on the first substrate;
threading a fastener through a second substrate, the first substrate, the pressure adhesive film, and into the nut; and
with the pressure adhesive film, preventing the nut from rotating relative to the first substrate and the pressure adhesive film as the fastener is threaded into the nut.

12. The method of claim 11, further comprising removing a layer from the pressure adhesive film to expose adhesive material of the pressure adhesive film for securing the pressure adhesive film to the first substrate.

13. The method of claim 11, further comprising cutting threads into a channel of the nut as the fastener is threaded into the nut to threadedly couple the fastener to the nut.

14. The method of claim 11, wherein preventing the nut from rotating relative to the first substrate and the pressure adhesive film when the fastener is threaded into the nut includes preventing the nut from rotating relative to the first substrate when threading the fastener to the nut after the nut is adhered to the first substrate with the pressure adhesive film.

15. The method of claim 14, wherein the preventing of the nut from rotating relative to the first substrate with only the pressure adhesive film is continuous from a start of the threading of the fastener into the nut to an end of the threading of the fastener into the nut.

16. The method of claim 11, wherein threading the fastener through the second substrate, the first substrate, the pressure adhesive film, and into the nut includes securing the first substrate to the second substrate.

17. The method of claim 11, wherein threading the fastener through the nut includes threading the fastener through a channel defined through the nut.

18. The method of claim 11, further comprising inserting an insert into the nut before threading the fastener into the nut, and wherein threading the fastener through the nut includes threading the fastener into the insert

19. The method of claim 11, further comprising securing the pressure adhesive film to the nut before securing the nut to the first substrate.

20. A fastening assembly, comprising:
a fastener;
a nut defining a channel and having an upper end portion and a lower end portion; and
a pressure adhesive material having a lower surface and an upper surface configured to secure to the lower end portion of the nut, the lower surface of the pressure adhesive material configured to adhere to a first substrate for securing the nut to the first substrate to prevent the nut from separating from the first substrate and to prevent the nut from rotating relative to the first substrate when the fastener is threaded into the nut for securing the first substrate to a second substrate.
